(19) United States
(12) Patent Application Publication
(10) Pub. No.: US 2026/0147556 A1
(43) Pub. Date: May 28, 2026

(54) METHOD AND APPARATUS FOR NETWORK BANDWIDTH-ADAPTIVE DEPLOYMENT AND INTEGRATION OF ROS APPLICATIONS

(71) Applicant: ELECTRONICS AND TELECOMMUNICATIONS RESEARCH INSTITUTE, Daejeon (KR)

(72) Inventor: Byoung Youl SONG, Daejeon (KR)

(21) Appl. No.: 19/372,869

(22) Filed: Oct. 29, 2025

(30) Foreign Application Priority Data
Nov. 27, 2024 (KR) 10-2024-0172881
Oct. 21, 2025 (KR) 10-2025-0153077

(51) Int. Cl. G06F 8/61

(52) U.S. Cl. CPC G06F 8/61

(57) ABSTRACT

A method for deploying and linking a ROS application package in a ROS-based distributed computed environment including multiple hosts includes: deploying a ROS application package to a specific host and predicting performance of a topic generated by a ROS-based module to which the ROS application package is deployed; measuring a maximum bandwidth between hosts for a plurality of hosts by using a network bandwidth measurement tool; generating localhost mode setting information based on the predicted performance; generating host-to-host middleware setting information based on the predicted performance; and transmitting a deployment command including the localhost setting information and the host-to-host middleware setting information to a target host.

### CROSS REFERENCE TO RELATED APPLICATIONS

This application claims the benefit of earlier filing date and right of priority to Korean Application No. 10-2024-0172881, filed on Nov. 27, 2024, Korean Application No. 10-2025-0153077, filed on Oct. 21, 2025, the contents of which are all hereby incorporated by reference herein in their entirety.

### BACKGROUND

### 1. Technical Field

The present disclosure relates to a method for deploying and linking ROS applications to achieve optimal performance depending on network bandwidth conditions, and apparatus for performing the same.

### 2. Description of Related Art

The Robot Operating System (ROS) is widely used in robotics research and development due to its modularity, ease of use, and community-driven growth. ROS uses a central server or a multicast-based discovery protocol to find communication peers, and then establishes connections using direct connections. The peer-to-peer connection process may be performed at the application level.

For example, when there are two different hosts a and b, let's assume a situation where there are N applications receiving topic (1) from host a and 1 application transmitting topic (1) from host b. In this case, a total of N connections are established between host a and host b, and therefore, a total of N duplicate transmissions occur for the same topic, which may cause a problem of significantly reducing topic performance under limited bandwidth.

### SUMMARY

The technical object of the present disclosure is to provide a method for predicting performance according to ROS-based application deployment.

It is a further object of the present disclosure to provide a method for establishing a communication path for ROS-based data between hosts via localhost mode or middleware depending on network bandwidth conditions.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for deploying and linking a ROS application package in a ROS-based distributed computed environment including multiple hosts, the method comprises: deploying a ROS application package to a specific host and predicting performance of a topic generated by a ROS-based module to which the ROS application package is deployed; measuring a maximum bandwidth between hosts for a plurality of hosts by using a network bandwidth measurement tool; generating localhost mode setting information based on the predicted performance; generating host-to-host middleware setting information based on the predicted performance; and transmitting a deployment command including the localhost setting information and the host-to-host middleware setting information to a target host, wherein the localhost mode setting information is information for setting a first ROS-based module deployed on a first host included in the target host to operate in localhost mode, and wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

In the method for deploying and linking the ROS application package in the ROS-based distributed computed environment including multiple hosts according to the present disclosure, the deployed ROS application package is subscribed to by at least two ROS application packages on the same host and publishes a large-capacity sensor type, wherein the large-capacity sensor type includes at least one of an image and a compressed image.

In the method for deploying and linking the ROS application package in the ROS-based distributed computed environment including multiple hosts according to the present disclosure, the specific host on which the ROS application package is distributed is determined based on host resource information, wherein the host resource information includes at least one of information includes at least one of information related to a hardware of a host and information on a ROS package running on the host, and the information related to the hardware of the host includes at least one of a name of the host, an IP address of the host, an operating system of the host, a dynamic storage size of the host, a static storage size of the host, and a CPU type.

In the method for deploying and linking the ROS application package in the ROS-based distributed computed environment including multiple hosts according to the present disclosure, the performance is predicted based on at least one of a total bandwidth of the topic and a decrease rate of the topic, the total bandwidth of the topic is predicted based on at least one of a size of the topic, a generation rate of the topic, a number of publishers of the topic, and a number of subscribers of the topic, and the decrease rate of the topic is predicted as a smaller value among 1 and a ratio of network bandwidth information of a link to the total bandwidth of the topic.

In the method for deploying and linking the ROS application package in the ROS-based distributed computed environment including multiple hosts according to the present disclosure, the size is measured using ‘ros2 topic bw’ command or API of ROS, and the generation rate is measured using ‘ros2 topic hz’ command or the API of the ROS.

In the method for deploying and linking the ROS application package in the ROS-based distributed computed environment including multiple hosts according to the present disclosure, when a link between the hosts is predicted, network bandwidth information of the link is generated by measuring a network bandwidth of the link or pre-measured network bandwidth information for the link is used.

In the method for deploying and linking the ROS application package in the ROS-based distributed computed environment including multiple hosts according to the present disclosure, the performance is predicted based on the receiving rate of the topic, and the receiving rate is predicted based on the generation rate and the decrease rate.

In the method for deploying and linking the ROS application package in the ROS-based distributed computed environment including multiple hosts according to the present disclosure, the first host is set as a host that generates the topic when the number of publishers or the number of subscribers is 2 or more and the decrease rate is 0.5 or less.

In the method for deploying and linking the ROS application package in the ROS-based distributed computed environment including multiple hosts according to the present disclosure, a first host-to-host middleware performing a client role is deployed on the first host, and a second host-to-host middleware performing a server role is deployed on the second host.

In the method for deploying and linking the ROS application package in the ROS-based distributed computed environment including multiple hosts according to the present disclosure, a topic in a localhost is collected from the first host-to-host middleware and transmitted to the second host-to-host middleware.

In the method for deploying and linking the ROS application package in the ROS-based distributed computed environment including multiple hosts according to the present disclosure, the deployment command is transmitted using a predetermined communication technique including at least one of ROS, zenoh, mqtt, and zmq or is transmitted through a communication channel, when the predetermined communication technique is used, a predetermined topic is published, and the predetermined topic is designated as/deployment.

In accordance with an aspect of the present disclosure, the above and other objects can be accomplished by the provision of an apparatus for deploying and linking the ROS application package in the ROS-based distributed computed environment including multiple hosts, the apparatus comprises: a performance prediction unit that deploys a ROS application package to a specific host and predicts the performance of a topic generated by a ROS-based module to which the ROS application package is deployed; a link bandwidth measurement unit that measures the maximum bandwidth between hosts for a plurality of hosts by using a network bandwidth measurement tool; a ROS-based module deployment configuration unit that generates localhost mode setting information based on the predicted performance; a host-to-host middleware setting information generation unit that generates host-to-host middleware setting information based on the predicted performance; and a deployment command transmission unit that transmits a deployment command including the localhost setting information and the host-to-host middleware setting information to a target host, wherein the localhost mode setting information is information for setting a first ROS-based module deployed on a first host included in the target host to operate in localhost mode, and wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

In accordance with an aspect of the present disclosure, the above and other objects can be accomplished by the provision of a method for deploying and linking the ROS application package in the ROS-based distributed computed environment including multiple hosts, the method comprises: receiving a deployment command including localhost mode setting information and host-to-host middleware setting information; and running a ROS-based module by interpreting the deployment command, wherein the localhost mode setting information is information for setting a first ROS-based module deployed on a first host included in a target host to operate in localhost mode, and wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

In the method for deploying and linking the ROS application package in the ROS-based distributed computed environment including multiple hosts according to the present disclosure, the method further comprises transmitting ROS host resource information for determining a specific host on which the ROS application package is deployed, the host resource information includes at least one of information includes at least one of information related to a hardware of a host and information on a ROS package running on the host, and the information related to the hardware of the host includes at least one of a name of the host, an IP address of the host, an operating system of the host, a dynamic storage size of the host, a static storage size of the host, and a CPU type.

In the method for deploying and linking the ROS application package in the ROS-based distributed computed environment including multiple hosts according to the present disclosure, the first host is set as a host that generates the topic when a number of publishers of a topic or a number of subscribers of the topic is 2 or more and the decrease rate of the topic is 0.5 or less.

In the method for deploying and linking the ROS application package in the ROS-based distributed computed environment including multiple hosts according to the present disclosure, a first host-to-host middleware performing a client role is deployed on the first host, and a second host-to-host middleware performing a server role is deployed on the second host.

In the method for deploying and linking the ROS application package in the ROS-based distributed computed environment including multiple hosts according to the present disclosure, a topic in a localhost is collected from the first host-to-host middleware and transmitted to the second host-to-host middleware.

In the method for deploying and linking the ROS application package in the ROS-based distributed computed environment including multiple hosts according to the present disclosure, the deployment command is received using a predetermined communication technique including at least one of ROS, zenoh, mqtt, and zmq or is received through a communication channel, when the predetermined communication technique is used, a predetermined topic is subscribed, and the predetermined topic is designated as/deployment.

In the method for deploying and linking the ROS application package in the ROS-based distributed computed environment including multiple hosts according to the present disclosure, based on the deployment command including binary data of the ROS-based module, the binary data is stored in a local storage, and based on the deployment command not including binary data of the ROS-based module, the presence of the binary data of the ROS-based module corresponding to at least one of “package” or “image” is checked.

In accordance with an aspect of the present disclosure, the above and other objects can be accomplished by the provision of an apparatus for deploying and linking the ROS application package in the ROS-based distributed computed environment including multiple hosts, the apparatus comprises: a deployment command receiving unit that receives a deployment command including localhost mode setting information and host-to-host middleware setting information; and a ROS-based deployment command running unit that runs a ROS-based module by interpreting the deployment command, wherein the localhost mode setting information is information for setting a first ROS-based module deployed on a first host included in a target host to operate in localhost mode, and wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating the structure of a ROS application deployment and linkage method and system according to one embodiment of the present disclosure.

FIG. 2 is a diagram illustrating an example of application according to one embodiment of the present disclosure.

FIG. 3 is a drawing illustrating the ROS-based module deployment command according to one embodiment of the present disclosure.

FIG. 4 is a diagram illustrating the deployment command including deployment information of a ROS-based module operating in a localhost mode, deployment information of a host-to-host middleware functioning as a client, and operation setting values of the middleware according to one embodiment of the present disclosure.

FIG. 5 is a flowchart of a method for deploying and linking ROS application packages according to one embodiment of the present disclosure.

FIG. 6 is a flowchart of a method for deploying and linking ROS application packages according to one embodiment of the present disclosure.

FIG. 7 is a diagram of an apparatus for deploying and linking ROS application packages according to one embodiment of the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this disclosure are briefly explained as follows.

A ROS application package may refer to a set of ROS-based modules designated in the form of either an independent ROS package executable by itself or a container image in which an executable ROS package is installed.

Middleware (or host-to-host middleware) may refer to an apparatus or software that enables hosts using different communication protocols to communicate with each other smoothly and exchange data. For example, the host-to-host middleware may include a ROS bridge or a gateway. Through the host-to-host middleware, transmission and receiving of data may be effectively managed.

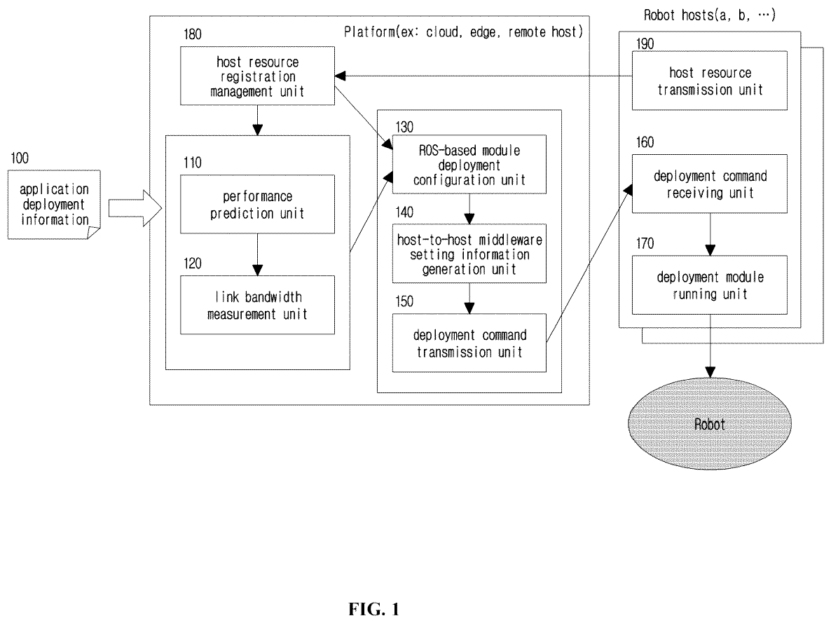

FIG. 1 is a diagram illustrating the structure of a ROS application deployment and linkage method and system according to one embodiment of the present disclosure.

Referring to FIG. 1, the network bandwidth adaptive ROS application package deployment and linking technology may include at least one of application deployment information 100, a performance prediction unit 110, a link bandwidth measurement unit 120, a ROS-based module deployment configuration unit 130, a host-to-host middleware setting information generation unit 140, a deployment command transmission unit 150, a deployment command receiving unit 160, a ROS-based deployment module running unit 170, a host resource registration management unit 180, and a host resource transmission unit 190.

Referring to FIG. 1, application deployment information 100 may include at least one of information for deploying ROS-based robot modules on multiple hosts, publication information and required information (subscription or service/action request in ROS) of ROS-based data in each robot module.

Publication information for ROS-based data may include topic publications or service/action advertisements in ROS. Required information for ROS-based data may include subscriptions or service/action requests in ROS.

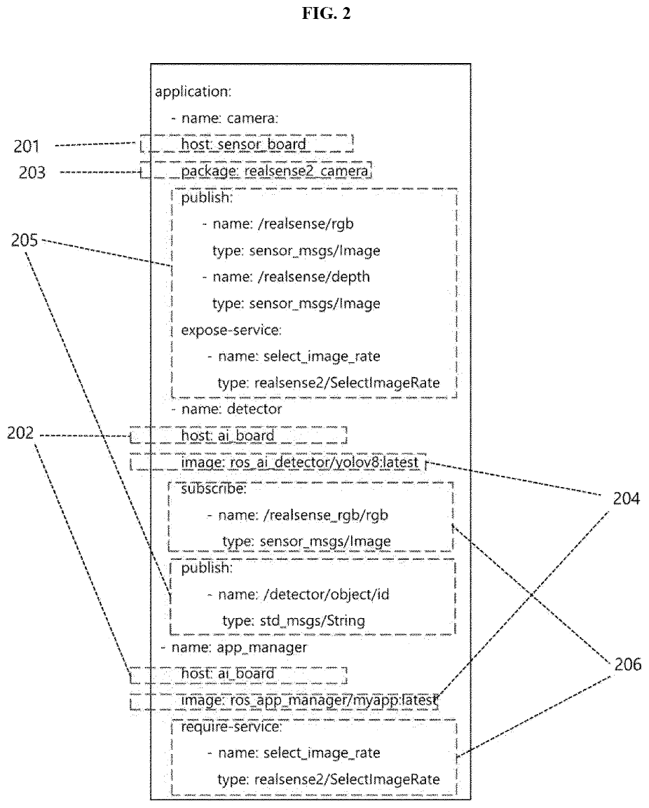

FIG. 2 is a diagram illustrating an example of application according to one embodiment of the present disclosure.

Referring to FIG. 2, application deployment information 100 may include at least one of deployment location information 201, 202 of an application package or a container containing an application package, source information 203, 204 of the application package, data publication information 205 in each package, or data required information 206 in each package.

Referring to FIG. 2, the deployment location information 201, 202 may be changed depending on the implementation method to text information (URL, IP, ID, etc.) that may distinguish the host.

Referring to FIG. 2, the source information of each package may designate a name 203 of a ROS package when the package is a ROS package and may designate a name 204 of a container image when the package is a container.

Referring to FIG. 2, data publication information 205 may include at least one of a topic name, a data type, a name of service or action invocable from outside, and a type of the service or action, for enabling data to be transmitted externally from an application package or a container including the application package.

Referring to FIG. 2, data required information 206 may include at least one of the name of a topic name, a data type, a name of service or action to be called externally, and a type of the service or action, for enabling an application package or a container including the application package to receive data internally.

Referring to FIG. 1, the performance prediction unit 110 may measure the bandwidth of the data topic of the ROS-based module included in the application deployment information.

Specifically, only a ROS-based application package that is subscribed to by two or more ROS application packages on the same host and publishes a large-capacity sensor type may be temporarily deployed and run on a designated host. Here, the large-capacity sensor type may include an image, a compressed image, etc. In this case, a size and/or a generation rate of a topic may be identified through topic measurement functions provided by ROS.

When measuring topic size, it may be measured through the ROS API, or in the case of ROS2, “ros2 topic bw” may be used. When measuring topic generation rate, it may be measured through the ROS API, or in the case of ROS2, “ros2 topic hz” may be used.

However, the disclosed example is merely an example, and the present disclosure is not limited to a specific means for measuring a size and/or a generation rate of a topic.

Referring to FIG. 1, the performance prediction unit 110 may obtain information about each host from the host resource registration management unit 180 for deployment for performance measurement. In addition, if the name and type of data publication information 205 of a ROS-based module of each host obtained from the application deployment information 100 and data required information 206 of a ROS-based module of another host match with each other, such that a link between hosts is predicted, a network bandwidth of the predicted link between hosts may be measured through a link bandwidth measurement unit 120, or network bandwidth information previously measured for the link may be utilized. The performance predicted when each topic receives information about the size of the topic, the generation rate of the topic, and/or the bandwidth information of the link may be measured based on the following mathematical equations 1 and 2.

$$B = {\sum }_{i ∈ T} {{{\sum }_{i ∈ H}}_{{j}^{′} ∈ H}}_{j \neq {j}^{′}} ( S ( i ) \cdot {R}_{p} ( i ) \cdot {N}_{p} ( i , j ) \cdot {N}_{S} ( i , {j}^{′} ) ) \qquad [ Mathematical Equation 1 ]$$

$$D = min ( 1 , \frac{L}{B} ) , {R}_{r} ( i ) = {R}_{p} ( i ) \cdot D \qquad [ Mathematical Equation 2 ]$$

Mathematical equation 1 is for the total bandwidth (B) of data topics predicted from application deployment. In mathematical equation 1, T may represent a set of topics, H may represent a set of hosts, S (i) may represent the message size of topic (i), Rₚ(i) may represent the generation rate of topic (i), Nₚ(I,j) may represent the number of publishers of topic (i) on host (j), and Nₛ(I,j′) may represent the number of subscribers of topic (i) on host (j′).

In mathematical equation 2, D may represent the topic receiving rate (hereinafter referred to as the decrease rate) that decreases due to application deployment, L may represent the link bandwidth between hosts, and B may represent the total bandwidth of data topics predicted from application deployment. The B may be a result calculated by applying mathematical equation 1. In mathematical equation 2, Rᵣ(i) may represent the predicted receiving rate of topic (i), Rₚ(i) may represent the generation rate of topic (i), and D may represent the decrease rate.

The link bandwidth measurement unit 120 may measure the maximum bandwidth during TCP and UDP transmission between hosts on the application deployment information using a network bandwidth measurement tool. The network bandwidth measurement tool may refer to an apparatus that measures data by transmitting and receiving data of a specific size between two hosts. The network bandwidth measurement tool may be implemented using a general network performance measurement tool (e.g., iperf) or through simple network programming.

However, the disclosed embodiment is merely an example, and the present disclosure does not limit the implementation method of the network bandwidth measurement tool.

The ROS-based module deployment configuration unit 130 may set the ROS-based module to be deployed on the host (k) or host (j′) containing the topic (i) from the application deployment information to operate in “localhost” mode, which does not transmit the ROS topic to the outside of the host, when the value of the decrease rate D is lower than a certain value (e.g., 0.5) for the topic (i) in which Nₚ(i,j) is 2 or more or Nₛ(i,j′) is 2 or more in mathematical equation 1.

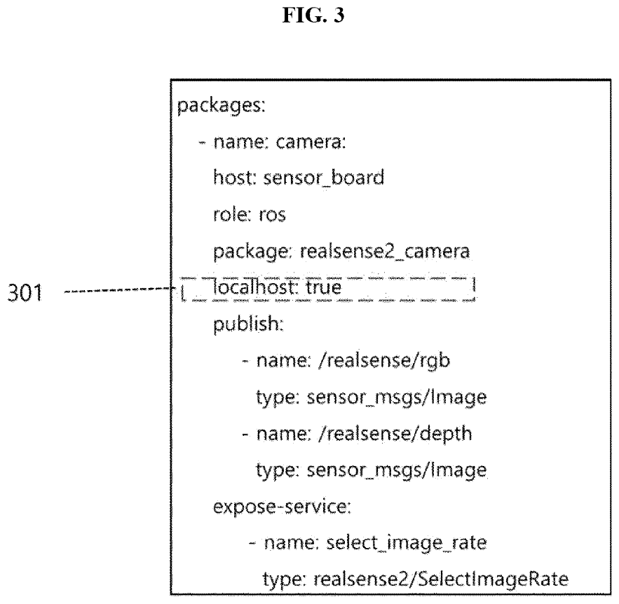

FIG. 3 is a drawing illustrating the ROS-based module deployment command according to one embodiment of the present disclosure.

Referring to FIG. 3, the ROS-based module deployment configuration method may operate in a manner of transmitting a command in which a “localhost” mode operation setting value 301 is added to the host package data containing a list of ROS-based modules to be deployed on a target host, based on application deployment information 100.

The host-to-host middleware setting information generation unit 140 may be configured to deploy host-to-host middleware (e.g., a ROS bridge or gateway application) corresponding to a client on the host where the ROS-based module that publishes the topic is deployed, and to deploy host-to-host middleware (e.g., a ROS bridge or gateway application) corresponding to a server on the host where the ROS-based module that subscribes to the topic is deployed, if a link exists between a host where a ROS-based module operating in “localhost” mode is deployed and another host where a ROS-based module subscribing to a topic published by the ROS-based module is deployed. After the configuration, the host-to-host middleware setting information generation unit 140 may configure an operation setting value for the host-to-host middleware corresponding to a client to collect topics in a localhost and transmit the collected topics to the host-to-host middleware serving as a server on another host.

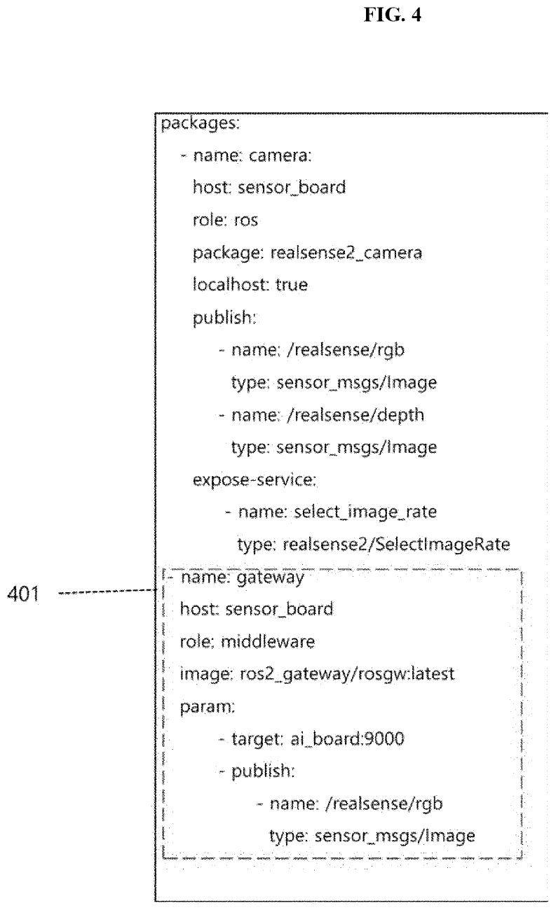

FIG. 4 is a diagram illustrating the deployment command including deployment information of a ROS-based module operating in a localhost mode, deployment information of a host-to-host middleware functioning as a client, and operation setting values 401 of the middleware according to one embodiment of the present disclosure.

The deployment command transmission unit 150 may transmit the information to each host when the deployment command is confirmed (e.g., as illustrated in FIG. 3 and/or FIG. 4). A publish/subscribe communication method may be used to transmit the deployment command to each host. For example, ROS, zenoh, mqtt, zmq, etc. can be used.

However, the disclosed publish/subscribe communication method is merely an example, and the present disclosure does not place any restrictions on the implementation method.

When using a publish/subscribe communication method to transmit a deployment command to each host, a specific topic (e.g., /deployment) in the communication method may be designated for publishing. Meanwhile, if a communication channel connected to the deployment command receiving unit 160 on each host exists, a deployment command may be transmitted through the communication channel. The deployment command may include, in addition to the deployment information illustrated in FIG. 3 and/or FIG. 4, the package binary data of an actual ROS module or binary data of a container image in which a ROS module is installed.

When using a publish/subscribe communication method, the deployment command receiving unit 160 may subscribe to a specific topic (e.g., /deployment) in the communication method and receive deployment information through the subscribed topic, or may wait for data receiving from the deployment command transmission unit 150 while maintaining a connection to the communication channel, and may confirm the deployment command through data.

The deployment module running unit 170 may interpret a deployment command (e.g., a deployment command as illustrated in FIG. 3 and/or FIG. 4) and prepare for execution of a ROS-based module. If the deployment command includes binary data of the ROS-based module, the received binary data may be stored in local storage. If the deployment command does not include binary data of the ROS-based module, check whether the binary data of the ROS-based module corresponding to the “package” or “image” (e.g., as shown in FIG. 3 and/or FIG. 4) exists in the local storage, and if not, download the binary data from the ROS package storage or container storage over the network and store it in the local storage. Thereafter, ROS-based module included in the deployment command may be run. In addition, if the deployment command includes middleware, the middleware may be run using the “param” value. For example, “param” may include a target host, data publication information, etc., as illustrated in FIG. 4 at reference numeral 401.

The host resource registration management unit 180 may collect information about connected robots and each host on the robot when developing or operating robot application. The collected information may include at least one of hardware-related information such as the host name, the host IP address, the host operating system, the host dynamic storage (memory) size, the host static storage (SSD, etc.) size, CPU type, or information about running ROS packages or container instances.

The host resource transmission unit 190 may collect information about an operating host and transmit it to the host resource registration management unit 180. The transmission method may be to directly transmit the host resource information by connecting to the host resource registration management unit 180, or to publish the host resource information to a specific topic (e.g., /host_info) using a publish/subscribe communication method.

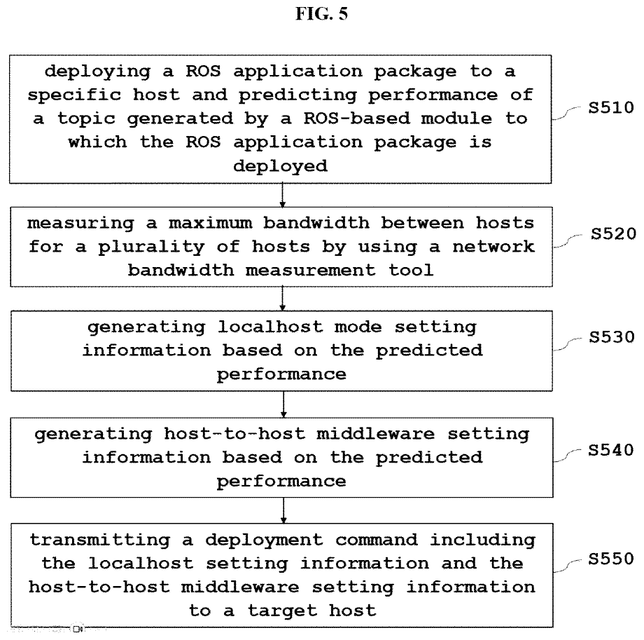

FIG. 5 is a flowchart of a method for deploying and linking ROS application packages according to one embodiment of the present disclosure.

Referring to FIG. 5, a ROS application package may be deployed to a specific host and performance of a topic generated by a ROS-based module to which the ROS application package is deployed may be predicted S510. The operation may be performed by the performance prediction unit 110.

According to one embodiment of the present disclosure, the performance prediction unit 110 may measure the bandwidth of the data topic of the ROS-based module included in the application deployment information 100. As the application deployment information has been described with reference to FIGS. 1 and 2, a detailed description thereof will be omitted here.

According to one embodiment of the present disclosure, the performance prediction unit 110 may obtain information about each host from the host resource registration management unit 180 for deployment for performance measurement.

Referring to FIG. 5, a maximum bandwidth between hosts may be measured for a plurality of hosts by using a network bandwidth measurement tool S520. The operation may be performed by a link bandwidth measurement unit 120.

Meanwhile, according to one embodiment of the present disclosure, the performance prediction unit 110 may measure the performance predicted when each topic receives information about the size of the topic, the generation rate of the topic, and/or the bandwidth information of the link may be measured based on the mathematical equations 1 and 2 described above.

Since the operations of the performance prediction unit 110 and the link bandwidth measurement unit 120 have been described with reference to FIG. 1, a detailed description thereof will be omitted to avoid redundant explanation.

Referring to FIG. 5, localhost mode setting information may be generated based on the predicted performance S530. The operation may be performed by a ROS-based module deployment configuration unit 130.

According to one embodiment of the present disclosure, the ROS-based module deployment configuration unit 130 may set the ROS-based module to be deployed on the host (k) or host (j′) containing the topic (i) from the application deployment information to operate in “localhost” mode, which does not transmit the ROS topic to the outside of the host, when the value of the decrease rate D is lower than a certain value (e.g., 0.5) for the topic (i) in which Nₚ(i,j) is 2 or more or Nₛ(i,j′) is 2 or more in mathematical equation 1.

According to one embodiment of the present disclosure, the ROS-based module deployment configuration method may operate in a manner of transmitting a command in which a “localhost” mode operation setting value 301 is added to the host package data containing a list of ROS-based modules to be deployed on a target host, based on application deployment information 100.

As for the generation of localhost mode setting information, as discussed with reference to FIGS. 1 and 3, a detailed description will be omitted here.

Referring to FIG. 5, host-to-host middleware setting information may be generated based on the predicted performance S540. The operation may be performed by host-to-host middleware setting information generation unit 140.

According to one embodiment of the present disclosure, the host-to-host middleware setting information generation unit 140 may be configured to deploy host-to-host middleware (e.g., a ROS bridge or gateway application) corresponding to a client on the host where the ROS-based module that publishes the topic is deployed, and to deploy host-to-host middleware (e.g., a ROS bridge or gateway application) corresponding to a server on the host where the ROS-based module that subscribes to the topic is deployed, if a link exists between a host where a ROS-based module operating in “localhost” mode is deployed and another host where a ROS-based module subscribing to a topic published by the ROS-based module is deployed.

According to one embodiment of the present disclosure, the host-to-host middleware setting information generation unit 140 may configure an operation setting value for the host-to-host middleware corresponding to a client to collect topics in a localhost and transmit the collected topics to the host-to-host middleware serving as a server on another host.

As for the generation of host-to-host middleware setting information, as described with reference to FIGS. 1 and 4, a detailed description will be omitted here.

Referring to FIG. 5, a deployment command including the localhost setting information and the host-to-host middleware setting information is transmitted to a target host S550. The operation may be performed by deployment command transmission unit 150.

As for the deployment command transmission, as described with reference to FIG. 1, a detailed description will be omitted here.

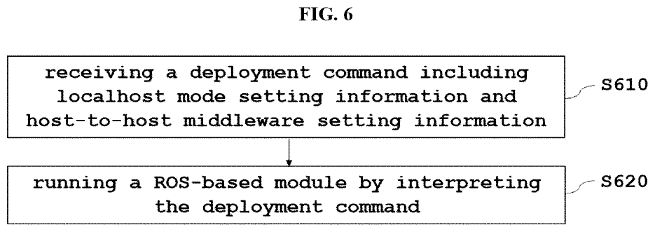

FIG. 6 is a flowchart of a method for deploying and linking ROS application packages according to one embodiment of the present disclosure.

Referring to FIG. 6, a deployment command including localhost mode setting information and host-to-host middleware setting information may be received S610. The operation may be performed by the deployment command receiving unit 160.

As for the deployment command receiving, as described with reference to FIG. 1, a detailed description will be omitted here.

Referring to FIG. 6, a ROS-based module is run by interpreting the deployment command S620. The operation may be performed by the deployment module running unit 170.

As for the deployment module running, as described with reference to FIG. 1, a detailed description will be omitted here.

Meanwhile, in one embodiment of the present disclosure, host resource information may be transmitted to determine a specific host on which a ROS application package is deployed. The operation may be performed by the host resource transmission unit 190.

As for the transmission of host resource information, as described with reference to FIG. 1, a detailed description will be omitted here.

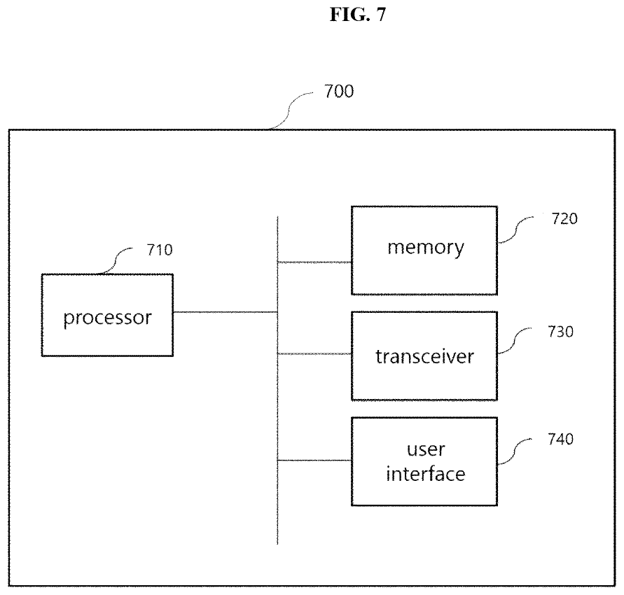

FIG. 7 is a diagram of an apparatus for deploying and linking ROS application packages according to one embodiment of the present disclosure.

The apparatus 700 may include one or more processors 710, one or more memories 720, one or more transceivers 730, one or more user interfaces 740, etc. The memory 720 may be included in the processor 710 or may be configured separately. The memory 720 may store instructions that cause the apparatus 700 to perform operations when executed by the processor 710. The transceiver 730 may transmit and/or receive signals, data, etc. that the apparatus 700 exchanges with other entities. The user interface 740 may receive an input of the user for the apparatus 700 or provide an output of the apparatus 700 to the user. Among the components of the apparatus 700, components other than the processor 710 and the memory 720 may not be included in some cases, and other components not shown in FIG. 7 may be included in the apparatus 700.

The processor 710 may be configured to cause the apparatus 700 to perform operations of the device according to various examples of the present disclosure. Although not illustrated in FIG. 7, the processor 710 may be configured as a set of modules each performing a function. The modules may be configured in the form of hardware and/or software.

The processor 710 of the apparatus 700 can generally support/perform operations such as deploying a ROS application package to a specific host and predicting performance of a topic generated by a ROS-based module to which the ROS application package is deployed; measuring a maximum bandwidth between hosts for a plurality of hosts by using a network bandwidth measurement tool; generating localhost mode setting information based on the predicted performance; generating host-to-host middleware setting information based on the predicted performance; and transmitting a deployment command including the localhost setting information and the host-to-host middleware setting information to a target host.

Here, the localhost mode setting information is information for setting a first ROS-based module deployed on a first host included in the target host to operate in localhost mode, and wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

The transceiver 730 of the apparatus 700 may be configured to transmit a deployment command including the localhost mode setting information and the host-to-host middleware setting information to the target host.

In this regard, a detailed description has been taken with reference to FIGS. 1 and 5, and a detailed description will be omitted here to avoid redundant explanation.

Alternatively, the transceiver 730 of the apparatus 700 may be configured to receive a deployment command including the localhost mode setting information and the host-to-host middleware setting information.

The processor 710 of the apparatus 700 may be configured to run a ROS-based module by interpreting the deployment command.

Here, the localhost mode setting information is information for setting a first ROS-based module deployed on a first host included in a target host to operate in localhost mode, and wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

In this regard, a detailed description has been taken with reference to FIGS. 1 and 6, and a detailed description will be omitted here to avoid redundant explanation.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for deploying and linking a ROS application package in a ROS-based distributed computed environment including multiple hosts, comprising:
deploying a ROS application package to a specific host and predicting performance of a topic generated by a ROS-based module to which the ROS application package is deployed;
measuring a maximum bandwidth between hosts for a plurality of hosts by using a network bandwidth measurement tool;
generating localhost mode setting information based on the predicted performance;
generating host-to-host middleware setting information based on the predicted performance; and
transmitting a deployment command including the localhost setting information and the host-to-host middleware setting information to a target host,
wherein the localhost mode setting information is information for setting a first ROS-based module deployed on a first host included in the target host to operate in localhost mode, and
wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

2. The method of claim 1, wherein the deployed ROS application package is subscribed to by at least two ROS application packages on the same host and publishes a large-capacity sensor type,
wherein the large-capacity sensor type includes at least one of an image and a compressed image.

3. The method of claim 1, wherein the specific host on which the ROS application package is distributed is determined based on host resource information,
wherein the host resource information includes at least one of information includes at least one of information related to a hardware of a host and information on a ROS package running on the host, and
wherein the information related to the hardware of the host includes at least one of a name of the host, an IP address of the host, an operating system of the host, a dynamic storage size of the host, a static storage size of the host, and a CPU type.

4. The method of claim 1, wherein the performance is predicted based on at least one of a total bandwidth of the topic and a decrease rate of the topic,
wherein the total bandwidth of the topic is predicted based on at least one of a size of the topic, a generation rate of the topic, a number of publishers of the topic, and a number of subscribers of the topic, and
wherein the decrease rate of the topic is predicted as a smaller value among 1 and a ratio of network bandwidth information of a link to the total bandwidth of the topic.

5. The method of claim 4, wherein the size is measured using ‘ros2 topic bw’ command or API of ROS, and the generation rate is measured using ‘ros2 topic hz’ command or the API of the ROS.

6. The method of claim 4, wherein when a link between the hosts is predicted, network bandwidth information of the link is generated by measuring a network bandwidth of the link or pre-measured network bandwidth information for the link is used.

7. The method of claim 1, wherein the performance is predicted based on the receiving rate of the topic, and
wherein the receiving rate is predicted based on the generation rate and the decrease rate.

8. The method of claim 4, wherein the first host is set as a host that generates the topic when the number of publishers or the number of subscribers is 2 or more and the decrease rate is 0.5 or less.

9. The method of claim 1, wherein a first host-to-host middleware performing a client role is deployed on the first host, and a second host-to-host middleware performing a server role is deployed on the second host.

10. The method of claim 9, wherein a topic in a localhost is collected from the first host-to-host middleware and transmitted to the second host-to-host middleware.

11. The method of claim 1, wherein the deployment command is transmitted using a predetermined communication technique including at least one of ROS, zenoh, mqtt, and zmq or is transmitted through a communication channel,
wherein when the predetermined communication technique is used, a predetermined topic is published, and
wherein the predetermined topic is designated as/deployment.

12. An apparatus for deploying and linking the ROS application package in the ROS-based distributed computed environment including multiple hosts, comprising:
a performance prediction unit that deploys a ROS application package to a specific host and predicts the performance of a topic generated by a ROS-based module to which the ROS application package is deployed;
a link bandwidth measurement unit that measures the maximum bandwidth between hosts for a plurality of hosts by using a network bandwidth measurement tool;
a ROS-based module deployment configuration unit that generates localhost mode setting information based on the predicted performance;
a host-to-host middleware setting information generation unit that generates host-to-host middleware setting information based on the predicted performance; and
a deployment command transmission unit that transmits a deployment command including the localhost setting information and the host-to-host middleware setting information to a target host,
wherein the localhost mode setting information is information for setting a first ROS-based module deployed on a first host included in the target host to operate in localhost mode, and
wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

13. A method for deploying and linking the ROS application package in the ROS-based distributed computed environment including multiple hosts, comprising:
receiving a deployment command including localhost mode setting information and host-to-host middleware setting information; and
running a ROS-based module by interpreting the deployment command,
wherein the localhost mode setting information is information for setting a first ROS-based module deployed on a first host included in a target host to operate in localhost mode, and
wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.

14. The method of claim 13, wherein the method further comprises transmitting ROS host resource information for determining a specific host on which the ROS application package is deployed,
wherein the host resource information includes at least one of information includes at least one of information related to a hardware of a host and information on a ROS package running on the host, and
wherein the information related to the hardware of the host includes at least one of a name of the host, an IP address of the host, an operating system of the host, a dynamic storage size of the host, a static storage size of the host, and a CPU type.

15. The method of claim 13, wherein the first host is set as a host that generates the topic when a number of publishers of a topic or a number of subscribers of the topic is 2 or more and the decrease rate of the topic is 0.5 or less.

16. The method of claim 13, wherein a first host-to-host middleware performing a client role is deployed on the first host, and a second host-to-host middleware performing a server role is deployed on the second host.

17. The method of claim 13, wherein a topic in a localhost is collected from the first host-to-host middleware and transmitted to the second host-to-host middleware.

18. The method of claim 13, wherein the deployment command is received using a predetermined communication technique including at least one of ROS, zenoh, mqtt, and zmq or is received through a communication channel,
wherein when the predetermined communication technique is used, a predetermined topic is subscribed, and
wherein the predetermined topic is designated as/deployment.

19. The method of claim 13, wherein based on the deployment command including binary data of the ROS-based module, the binary data is stored in a local storage, and
Wherein based on the deployment command not including binary data of the ROS-based module, the presence of the binary data of the ROS-based module corresponding to at least one of “package” or “image” is checked.

20. An apparatus for deploying and linking the ROS application package in the ROS-based distributed computed environment including multiple hosts, comprising:
a deployment command receiving unit that receives a deployment command including localhost mode setting information and host-to-host middleware setting information; and
a ROS-based deployment command running unit that runs a ROS-based module by interpreting the deployment command,
wherein the localhost mode setting information is information for setting a first ROS-based module deployed on a first host included in a target host to operate in localhost mode, and
wherein the inter-host middleware setting information is information for setting inter-host middleware to be deployed on the first host on which the first ROS-based module set to operate in localhost mode is deployed and on a second host on which a second ROS-based module subscribing to a topic published by the first host is deployed.
